(19) United States
(12) Patent Application Publication
(10) Pub. No.: US 2015/0317878 A1
(43) Pub. Date: Nov. 5, 2015

(54) JACKPOT CONTRIBUTION MECHANISM

(71) Applicant: Eclipse Gaming Systems, LLC, Lawrenceville, GA (US)

(72) Inventor: Jack Saltiel, Lawrenceville, GA (US)

(73) Assignee: Eclipse Gaming Systems, LLC, Lawrenceville, GA (US)

(21) Appl. No.: 14/269,285

(22) Filed: May 5, 2014

(51) Int. Cl. G07F 17/32

(52) U.S. Cl. CPC G07F 17/3258

(57) ABSTRACT

In one embodiment, a method comprising receiving indications of a game event from one or more of a plurality of gaming machines, the game event corresponding to an outcome of an instance of game play; and automatically contributing to a progressive pool based on the indications.

### TECHNICAL FIELD

The present disclosure is generally related to electronic gaming systems and, more particularly, casino-type electronic gaming systems.

### BACKGROUND

Casino-type electronic gaming systems encompass a variety of gaming markets, including U.S. tribal gaming, licensed gaming, charitable gaming, and video lottery and electronic pull-tab applications. One feature common to many gaming products is a progressive award or bonus. Progressive bonuses typically refer to bonuses that are awarded based on chance, where the bonus consists of an accumulation of money that has been collected as a percentage of all wagers. For instance, in the case of common “must-go” bonuses or prizes, the bonus comprises a hidden or advertised level, beyond which the bonus is awarded to the player with the next winning hand. The bonus is awarded when a predetermined threshold has been met.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1B are screen diagrams that illustrate example screen displays provided on an embodiment of an example gaming machine.

FIG. 2 is a block diagram of an embodiment of an example community progressive pool system.

FIG. 3 is a flow diagram that illustrates an embodiment of an example community progressive pool method.

### DESCRIPTION OF EXAMPLE EMBODIMENTS

### Overview

In one embodiment, a method comprising receiving indications of a game event from one or more of a plurality of gaming machines, the game event corresponding to an outcome of an instance of game play; and automatically contributing to a progressive pool based on the indications.

### Detailed Description

Certain embodiments of a community progressive pool system and method are disclosed that contributes to, or equivalently, increments a progressive pool based on a game event (e.g., an outcome, such as a winning and/or losing outcome) from each of a plurality of gaming machines. In one embodiment, winning or losing entries from a pay table stored in a game server coupled to the plurality of gaming machines may be used to automatically add additional amounts to the progressive pool for the potential benefit of a community of players (e.g., playing games on the plurality of gaming machines). These entries are populated based on the indications (e.g., signaling triggered by the game event(s)) of one or more outcomes from games played on the plurality of gaming machines. The signaling may be triggered from a gaming event, such as the player winning at Bingo, or a winning Blackjack hand, or matched-up symbols, and coinciding with a winning pattern (e.g., Bingo, cards, virtual reel symbols, etc.) displayed on the screen display and/or other gaming events (e.g., matching a portion of symbols, duration of game play, etc.), or even upon a losing outcome. In some embodiments, based on the progressive pool reaching or exceeding a threshold value, the probability of winning a bonus from the progressive pool is increased.

Digressing briefly, conventional progressive pools may be supplemented by an individual player or players, or by the Casino in addition to the typical wager-based contributions from each gaming machine to the progressive pool. For instance, a Casino may add to the progressive pool (e.g., for a defined duration) as a promotion, such as when a game is first introduced to the Casino (e.g., to attract players), or due to a holiday or other event outside of game play. In contrast, certain embodiments of a community progressive pool system supplement the normal wager-based progressive pool contribution with an addition to the progressive pool as a player-driven event, such as from winning or losing outcomes of a given game, enabling the progressive pool award or bonus (award and bonus herein used interchangeably) to be offered and awarded to a community of players. In some embodiments, the probability of awarding the bonus (e.g., through a final winning outcome at the increased probability) may be enhanced after the progressive pool reaches or exceeds one or a plurality of threshold levels.

Having summarized certain features of one or more community progressive pool systems of the present disclosure, reference will now be made in detail to the description of the disclosure as illustrated in the drawings. While the disclosure will be described in connection with these drawings, there is no intent to limit it to the embodiment or embodiments disclosed herein. Further, although the description identifies or describes specifics of one or more embodiments, such specifics are not necessarily part of every embodiment, nor are all of any various stated advantages necessarily associated with a single embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

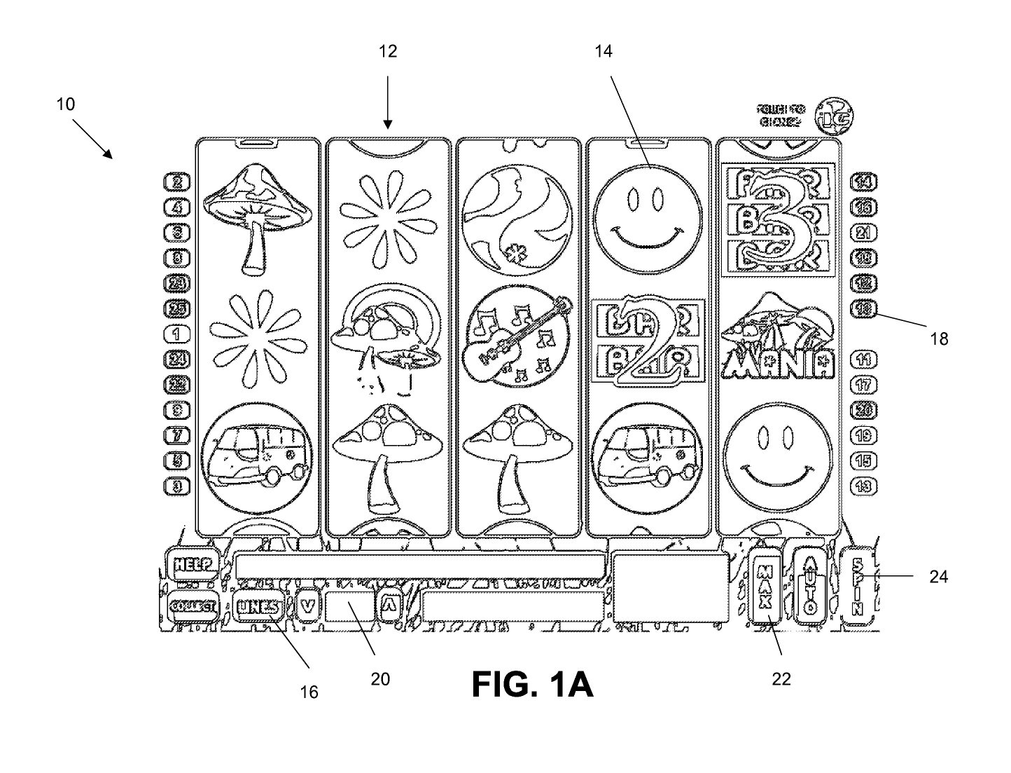

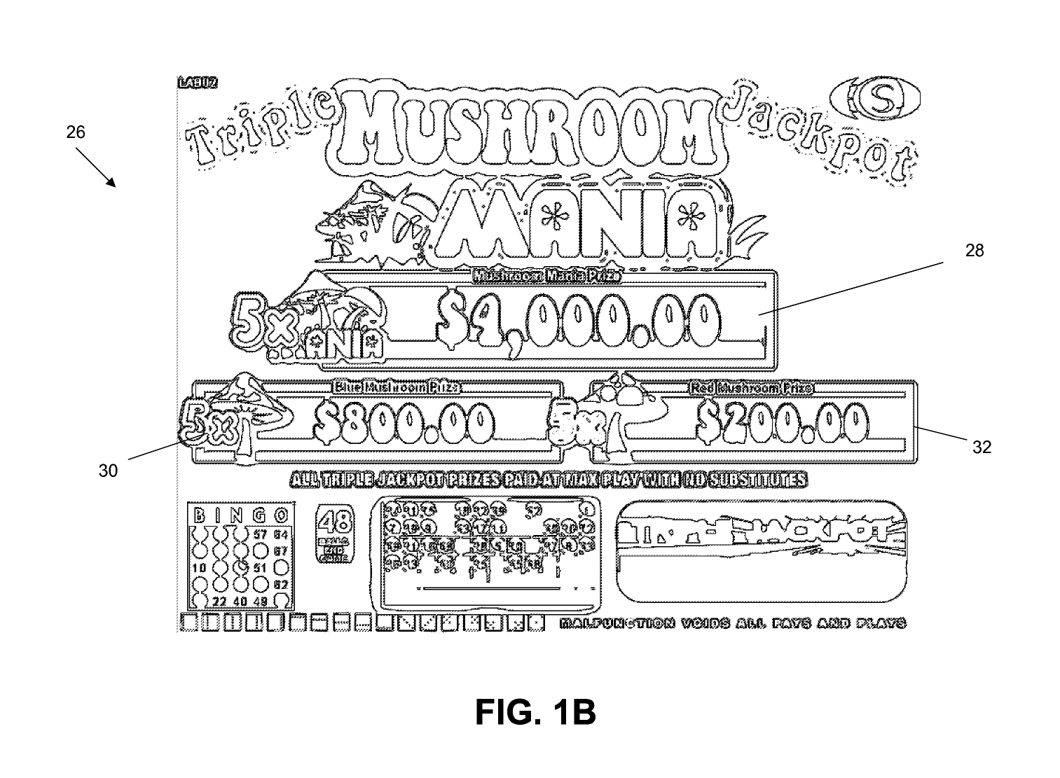

FIGS. 1A and 1B depict some example screen displays (also referred to herein as a graphical user interface or GUI) of an embodiment of a game with a community progressive pool system that may be presented on one or more gaming machines. It should be appreciated within the context of the present disclosure that the screen displays are merely one example among many, and that in some embodiments, other designs and/or features may be presented to a player. Note that the phrase “gaming machine,” as is known, may refer to any device that enables any activity or mode of play for gaming (i.e., gambling or redemption), amusement, competition, or other purposes. Additionally, the phrase “gaming machine” may refer to a “stand alone” player station or console in which case the outcome of game play is determined locally, or as part of a server-based network or bank of gaming machines in which case the outcome of game play is centrally determined. For instance, a gaming machine may be configured as an upright cabinet, as is known, and presents the screen display of FIG. 1A on a lower portion of a cabinet, and the screen display of FIG. 1B on an upper portion of the cabinet. The cabinet may include a wager interface or interfaces (e.g., currency input/output port, card reader, etc.), touch-screen displays, electromechanical buttons, or a combination of touch-screen displays and electromechanical buttons. For example, for a Blackjack game, the electromechanical buttons may include options for placing a bet, cashing out, hitting or standing, doubling down, purchasing insurance and/or splitting. Alternatively, in a poker game, the electromechanical buttons may include options for placing a bet, cashing out and/or designating which cards to keep and which to discard. In one embodiment, the screen displays may be configured as “touch screen” types upon which icons corresponding to some or all of the electromechanical buttons appear, or graphical icons manipulated and/or “selected” by toggles, joysticks, a mouse, among other user interface tools.

In the examples depicted in FIG. 1A, the screen display 10 is embodied as a virtual reel game having plural columns or reels 12 of symbols 14 that “spin” to visually (and audibly in some games) reflect an underlying probabilistic mechanism, such as random or pseudo-random number generation implemented in software, hardware, or a combination of both. It should be appreciated that other electronic games may be used, including video bingo, video poker, video keno or video blackjack, etc., and hence are contemplated to be within the scope of the disclosure. The screen display 10 also presents a payline options icon 16 that enables the player to select (e.g., on-screen via a manipulated cursor or via touch-screen, or via electromechanical buttons on the cabinet) from a plurality of different paylines, which are also highlighted on each side of the screen 10, such as via payline icon 18. The paylines 18 define winning combinations of the reel symbols 14 or other representations of winning combinations depending on the game selected by the player. The screen display 10 enables other user input (e.g., directly via on-screen selection or indirectly), as is known, to enable the player to select wager amounts 20 for each payline selected.

Also included are various button icons to enable the player to control an instance or instances of game play, such as selecting a max bet option 22 and to spin the reels 24. The max bet option 22 is a higher-stakes form of wager, and may or may not be required to enable a player to win a progressive pool bonus.

Referring to FIG. 1B, shown is an example screen display 26 that, in one embodiment, may be presented on a top portion of the aforementioned cabinet. The screen display 26 provides three levels of progressive pools, including an ultimate prize award 28 and two must-go bonuses 30 and 32 as is known in the industry. Certain embodiments of the progressive pool system may cause the odds of winning to change for each of these progressive pools, or a subset thereof. The focus hereinafter will be on a single progressive pool (e.g., the ultimate prize award 28), with the understanding that other pools (or more than one progressive pool) may have odds that are changed in some embodiments.

Although described in the context of a progressive pool comprising an ultimate prize award 28 presented on the screen display (e.g., screen display 26, FIG. 1B) of one or more gaming machines, one having ordinary skill in the art would understand that the progressive pools may be displayed (e.g., in addition to, or in lieu of one or more display screens 26) on another, stand-alone screen display for a group or community of players (and possibly other members of the gaming public in, for instance, a given casino) to collectively view from their respective gaming machines. As the community progressive pool system reaches or exceeds a predefined threshold value (or in some embodiments, plural threshold values, wherein meeting or exceeding each threshold results in an incremental increase in the odds of winning), the chances of winning the ultimate prize award 28 of the community progressive pool system increases. For instance, In one embodiment, a pay table may be embodied as a data structure (e.g., which may be an XML data structure, among other software configurations as should be appreciated by one having ordinary skill in the art) that defines a plurality of thresholds or levels. For each threshold, there is an event defined (e.g., the progressive pool>$50, the progressive pool>$50×Max Bet, etc.) and a pay table level. The data structure may be modified (e.g., in real-time, such as while playing a particular game) to change characteristics of the game by changing the definition of events. These changes to the definition of events may be implemented without changing the underlying pay table or any programming. The progressive pool data structure may be configured according to a plurality of bands within a range of zero (0) to one (1.0). Each band may represent a threshold or event that has occurred. The different bands in the progressive pool data structure enable different outcomes in the pay table to occur generally at higher probabilities as the process moves through the different bands. For instance, a played game may operate at a base probability level until the occurrence of an event (e.g., threshold reached or exceeded), after which the game increases the chances of winning the progressive pool (e.g., making it easier to win). As each threshold has been met or exceeded, the pay table changes the odds of winning the progressive pool. Stated otherwise, and using a simple example, at a first band of the progressive pool data structure, a progressive pool at a $20 base prize may be enabled in the pay table with odds of 10,000:1 (e.g., probability=0.0001). At a second band (e.g., second threshold), the $20 base prize may be enabled at odds of 1,000:1 (e.g., probability=0.001). This progressive, step-wise increase in probability continues to a defined level (e.g., 10:1, where probability=0.1). At this point, one of the players of a given bank of gaming machines soon wins a predefined prize on the base game, which results in a win at these increased odds of the progressive bonus. At the lower odds, it does not take many games to win the bonus. Note that in some embodiments, a single threshold may be used.

The increased probability may be manifested to the player of the game visually, such as an increased in brightness of the progressive pool value. In some embodiments, the increased probability may be manifested to the player of the game as a pulsing of the digits, larger fonts, or progressively-enhanced surrounding lighting, among other visual indicators. In some embodiments, the increased probability may be manifested to the player of the game audibly (e.g., louder or different sounds), and/or via a tactile enhancement (e.g., increased vibration of the machine or controls, etc.).

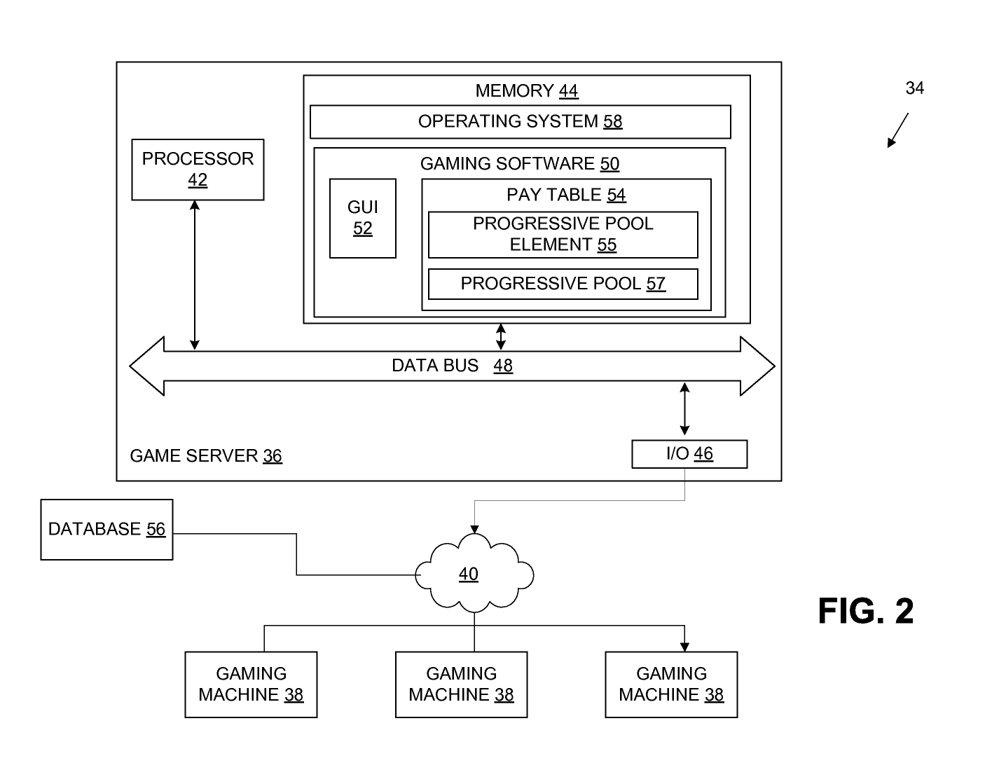

Attention is now directed to FIG. 2, which depicts an embodiment of an example community progressive pool system 34. It should be appreciated within the context of the present disclosure that fewer, additional, or different components may be used in some embodiments, and hence are contemplated to be within the scope of the disclosure. The community progressive pool system 34 comprises one or more game servers 36 (one shown) that is coupled to a plurality of individual gaming machines 38 (e.g., a bank of three (3) gaming machines 38 in this example, though fewer or greater numbers of gaming machines 38 may be used) via a network 40 (e.g., a local area network (LAN) such as an Ethernet connection, a wide area network (WAN), WiFi, etc.). Each gaming machine 38 may be located locally or remotely with respect to one another. The game server 36 includes one or more processors 42, memory 44, and an input/output (I/O) interface 46, coupled together via one or more data busses, such as data bus 48.

In one embodiment, the game server 36 can implement gaming software 50. The gaming software 50 can be implemented in software, as an executable program, and can be executed by a special or general purpose digital computer, such as a personal computer (PC, IBM-compatible, Apple-compatible, or otherwise), workstation, minicomputer, or mainframe computer. The gaming software 50 includes a graphical user-interface (GUI) module 52 that, through execution by the processor 42, provides the screen displays described above. Web-page or screen display generation and formatting mechanisms involved in generating the various displays are known in the art and, therefore are not discussed here. The gaming software 50 also includes one or more data structures, such as one or more pay table(s) 54. The gaming software 50 enables, through the use of the GUI 52, the pay table(s) 54, among other data structures (e.g., associated with the displayed progressive pool, for optionally implementing plural thresholds, etc.), and execution by the processor 42, the incrementing of the progressive pool from one or more game events (e.g., outcomes from game play, or certain triggers within an instance of game play, etc.) among the bank of gaming machines and optionally the changed probabilities of a payout of a bonus from the progressive pool.

The pay table 54 includes some conventional features well-known in the art. For instance, the pay table defines all possible outcomes of one play of a game that can result in awarding a prize to a player. For instance, each entry in the pay table may correspond to the amount of money required to be played, the criteria that defines a win (e.g., patterns of symbols), the odds of the win criteria resulting from one play of the game, and the amount of money (e.g., a list of payouts) returned by the gaming machine to the player when the win is registered. In addition, the pay table 54 contains (or in some embodiments is coupled to) a progressive pool data element 55 (e.g., one or more entries of the pay table) corresponding to a progressive pool 57 (e.g., the bank or pool which holds all contributions until a prize is awarded), enabling certain winning or losing outcomes corresponding to the pay table 54 to augment the progressive pool with an additional contribution. That is, the progressive pool data element (herein, also progressive pool element) 55 comprises one or more entries in the pay table 54 that specifies, for a given outcome, whether and/or how much of an increment (e.g., value increment) is to be contributed to the progressive pool 57. As is known, the progressive pool 57 is progressively increased in value (e.g., monetary value) based on each wager for each game played on the gaming machines 38. Such contributions to the progressive pool 57 are further supplemented from additional entries of the progressive pool element 55 within an embodiment of the pay table 54. In other words, the pay table 54 is configured with one or more additional entries of the progressive pool element 55, each entry enabling an incremental increase in value for the progressive pool 57 in response to receipt of an indication of a game event (e.g., win and/or loss or other triggering events occurring during game play) from each of a plurality of games based on the respective payline. For instance, the increment may be based on a percentage of the amount won at each game, or a predetermined amount of money in the case of player loss at a game, or the incremental amount may be based on a multiple of the amount wagered.

Additional software modules (integrated with the gaming software 50 or separate in some embodiments) are also included in the memory 44, though not shown for brevity, including random number generation software for generating winning combinations (e.g., cards, bingo balls, reels, etc.), among other functions, as should be understood by one having ordinary skill in the art. In some embodiments, random number generation may be achieved through hardware, or a combination of hardware and software. Although shown integral to the gaming software 50, one having ordinary skill in the art should understand in the context of this disclosure that the GUI module 52, the pay table 54, the progressive pool element 55, the progressive pool 57, and/or any other data structures may be separate modules or structures distributed among various components or devices, and that each module may be further configured using a plurality of submodules. In some embodiments, all or a portion of the aforementioned functionality associated with the gaming software 50 may be distributed among a plurality of devices of the community progressive pool system 34, or performed in each device of the system 34. For instance, in some embodiments, the gaming software 50 (and accompanying modules) may be located in each gaming machine 38, in addition to or in lieu of being located in game server(s) 36.

The data bus 48 may be, for example, one or more buses or other wired or wireless connections, and may have additional elements (not shown) to enable communications, such as controllers, buffers (caches), drivers, repeaters, and receivers. Further, the data bus 48 may include address, control, and/or data connections to enable appropriate communications among the aforementioned components. The game server 36 and/or gaming machines 38 may also communicate with a database 56 via the network 40. The database 56 may be external to or integral to game server 36.

The processor 42 is a hardware device capable of executing software, particularly that stored in memory 44. The processor 42 can be any custom made or commercially available processor, a central processing unit (CPU), an auxiliary processor among several processors associated with the game server 36, a semiconductor based microprocessor (in the form of a microchip or chip set), a macroprocessor, or generally any device for executing software instructions.

The memory 44 comprises a non-transitory, computer-readable medium, and may include any one or combination of volatile memory elements (i.e., random access memory) such as DRAM, SRAM or SDRAM and non-volatile memory elements such as ROM, hard drive, tape or CDROM. Moreover, the memory 44 may incorporate electronic, magnetic, optical, and/or other types of storage media. Note that memory 44 can have a distributed architecture where various components are situated remote from one another but can be accessed by the processor 42.

The software in memory 44 may include one or more separate programs, each of which comprises an ordered listing of executable instructions for implementing logical functions. In one embodiment of the game server 36, the software in the memory 44 includes the gaming software 50 and a suitable operating system (O/S) 58. The operating system 58 controls the execution of other computer programs, such as the gaming software 50 and the accesses and/or increments to the data structures 54, 55, and/or 57, and provides scheduling, input-output control, file and data management, memory management, and communication control and related services, as is known.

The gaming software 50 may be a source program, executable program (object code), script, and/or any other entity comprising a set of instructions to be performed. When a source program, the program may be translated via a compiler, assembler, interpreter, or the like, which may or may not be included within memory 44, so as to operate properly in connection with the operating system 58. Furthermore, the gaming software 50 can be written as (a) an object oriented programming language, which has classes of data and methods, or (b) a procedure programming language, which has routines, subroutines, and/or functions, including but not limited to, C, C++, Pascal, Basic, Fortran, Cobol, Perl, Java, ASP, XML, and Ada.

The gaming software 50 may be stored on any non-transitory, computer readable medium for use by or in connection with any computer related system or method. In the context of this document, a computer readable medium is an electronic, magnetic, optical, or other physical device or means that can contain or store a computer program for use by or in connection with a computer related system or method. The gaming software 50 can be embodied in any non-transitory, computer-readable medium for use by or in connection with an instruction execution system, apparatus, or device, such as a computer-based system, processor-containing system, or other system that can fetch the instructions from the instruction execution system, apparatus, or device and execute the instructions.

The I/O interfaces or devices 46 may include input devices such as a keyboard, mouse, scanner, grid from a touch-screen display, electromechanical buttons, microphone, etc., as well as interfaces to various devices (e.g., an interface to one or more progressive gaming machines 38 as shown in FIG. 2). Furthermore, the I/O devices 46 may also include output devices, such as a printer, display, etc. Finally, the I/O devices 46 may further include devices that communicate both inputs and outputs, for instance a modulator/demodulator (modem for accessing another device, system, or network), a radio frequency (RF) or other transceiver, a telephonic interface, a bridge, a router, etc. In one embodiment, a separate progressive display (e.g., to display progressive bonuses or awards remote from the gaming machines 38) may be connected to the I/O interface 46.

When the game server 36 is in operation, the processor 42 is configured to execute software stored within memory 44, to communicate data to and from memory 44, and to generally control operations of game server 36 pursuant to the software. The gaming software 50 and the operating system 58, in whole or in part, but typically the latter, are read by the processor 42, perhaps buffered within the processor 42, and then executed.

In some embodiments, the gaming software 50 may be located wholly or partially in the gaming machine 38 or may be split between the game server 36 and gaming machine 38. Often the random number generator resides in the game server 36 while the remainder of the gaming software 50 resides in the gaming machine 38.

To the extent certain components of the game server 36 are implemented at least in hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

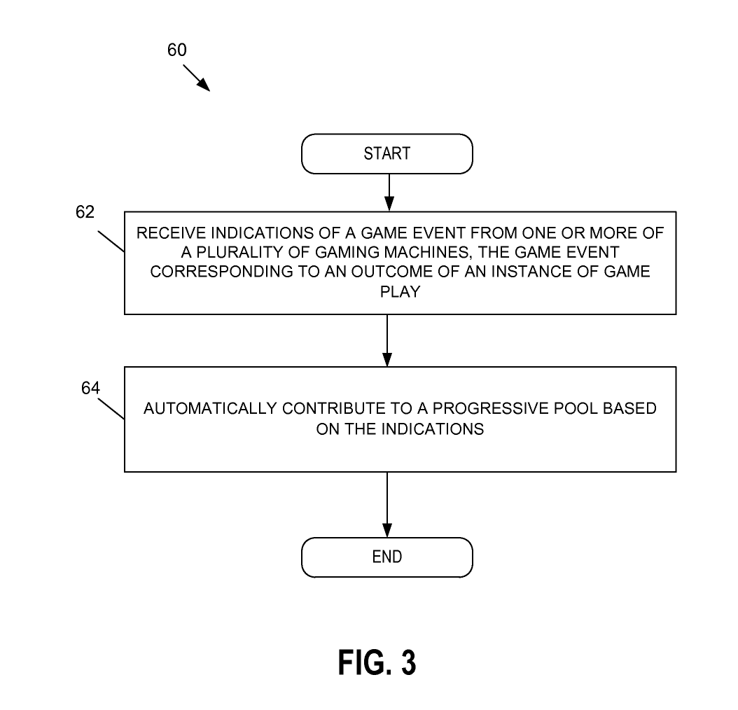

Having described an example embodiment of a community progressive pool system 34, and in view of the above description, it should be appreciated that one embodiment of a community progressive pool method, as depicted in FIG. 3 and denoted as method 60, comprises receiving indications of a game event from one or more of a plurality of gaming machines, the game event corresponding to an outcome of an instance of game play (62); and automatically contributing to a progressive pool based on the indications (64). Note that receiving of indications may be performed by a general purpose processor. As to the contribution features (e.g., incrementing features), the processor 42, executing the software 50, accesses a particular outcome entry of the pay table 54 corresponding to the game event (e.g., during an instance of game play). The processor 42, executing the software 50, increments the value in an entry in the progressive pool 57 as specified by the accessed outcome entry (e.g., whether a winning or losing outcome) based on the progressive pool element 55. For instance, while accessing an entry of the pay table 54 according to a user-specified payline, the gaming software 50 determines from the accessed entry whether there is an incrementing value to be applied to the current value in the progressive pool 57, and if so, what incrementing value to apply (e.g., a predetermined, absolute value or percentage value based on, for instance, a wager amount, or a predetermined value for a losing outcome, etc.) to increment the corresponding progressive pool.

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A system, comprising:
a memory system configured to store software and a pay table comprising plural entries, wherein one of the entries corresponds to a progressive pool; and
a processor configured by the software to:
receive indications from one or more gaming machines, each indication corresponding to a game event from at least one of the one or more gaming machines, the game event corresponding to a losing outcome associated with one of the plural entries of the pay table; and
automatically increment a value in the progressive pool based on receipt of the indications.

2. The system of claim 1, wherein the processor is further configured by the software to increment the value in the progressive pool based on a winning outcome at the one or more gaming machines and a second value in a progressive pool element.

3. The system of claim 1, wherein the processor is further configured by the software to increase a probability for winning a progressive pool award corresponding to the incremented value in the progressive pool based on the incremented value in the progressive pool reaching or exceeding a predetermined threshold value.

4. The system of claim 1, wherein the indications are triggered by the game events.

5. The system of claim 7, wherein each game event comprises an underlying game outcome and a corresponding predefined pattern of symbols presented on a display of the one or more gaming machines.

6. The system of claim 1, wherein the processor is configured by the software to provide an award corresponding to the incremented value in the progressive pool based on a winning outcome of a game played at one of the one or more gaming machines.

7. The system of claim 6, wherein the processor is configured by the software to cause a display of the award at an electronic device, at respective displays of the one or more gaming machines, or at the displays of the electronic device and the one or more gaming machines.

8. The system of claim 6, wherein the processor is configured by the software to provide an award corresponding to the incremented value in the progressive pool based on a winning outcome of a game played at one of the one or more gaming machines and based on the incremented value reaching or exceeding a predetermined threshold value.

9. The system of claim 8, wherein the processor is configured by the software to cause a display of the award at an electronic device, at respective displays of the one or more gaming machines, or at the displays of the electronic device and the one or more gaming machines.

10. The system of claim 1, wherein the processor is further configured by the software to automatically increment the value based on an absolute or relative value increment.

11. The system of claim 1, wherein the processor is further configured by the software to automatically increment the value based on a value increment that is a multiple of a wager entered as input at the one or more gaming machines.

12. A system comprising:
a plurality of gaming machines coupled to a network; and
a game server coupled to the plurality of gaming machines via the network, the game server configured to:
receive indications from the plurality of gaming machines, each indication corresponding to a game event at one of the plurality of gaming machines, the game event corresponding to an outcome of an instance of game play; and
automatically contribute to a progressive pool based on the indications.

13. The system of claim 12, wherein the game server is configured to contribute to the progressive pool based on a winning outcome at one or more of the plurality of gaming machines and a second value in a progressive pool element.

14. The system of claim 12, wherein the game server is configured to contribute to the progressive pool based on a losing outcome at the one or more of the plurality of gaming machines a second value in a progressive pool element.

15. The system of claim 12, wherein the game server is further configured to increase a probability for a plurality of players associated with the plurality of gaming machines to win an award from the progressive pool, the plurality of players including the player, wherein the award is based on a value in the progressive pool reaching or exceeding a predetermined value.

16. The system of claim 12, wherein the game server comprises a pay table with plural entries, each entry associated with a respective outcome among a plurality of outcomes, the pay table further comprising one or more progressive pool elements.

17. The system of claim 16, wherein the game server is configured to contribute to the progressive pool from the one or more progressive pool elements.

18. The system of claim 12, wherein the indications are triggered by the game events.

19. The system of claim 12, wherein the game server is configured to provide an award from the progressive pool based on the progressive pool reaching or exceeding the predetermined value and based on a final winning outcome of the game played at one of the plurality of gaming machines.

20. A method, comprising:
receiving indications of a game event from one or more of a plurality of gaming machines, the game event corresponding to an outcome of an instance of game play; and
automatically contributing to a progressive pool based on the indications.
